(19) United States
(12) Patent Application Publication
(10) Pub. No.: US 2008/0250505 A1
(43) Pub. Date: Oct. 9, 2008

(54) Methods And Systems For Generating A Symbol Identification Challenge

(76) Inventor: Jason David Koziol, Naperville, IL (US)

Correspondence Address: MANISHA CHAKRABARTI, 3108 S. RT. 59, STE. 124-282, NAPERVILLE, IL, 60564, US

(21) Appl. No.: 11/697,293

(22) Filed: Apr. 5, 2007

(51) Int. Cl. G06F 17/00

(52) U.S. Cl. 726/27

(57) ABSTRACT

The generation of a representation of a symbol that poses an identification challenge for an automated agent is disclosed. A symbol image of a symbol is generated. At least one non-symbol image is generated. A display mechanism is provided where the display mechanism is operable to display the symbol image and the at least one non-symbol image.

### FIELD OF THE INVENTION

The present invention generally relates to data security and more particularly to methods and systems for generating a symbol identification challenge for an automated agent.

### BACKGROUND OF THE INVENTION

Sensitive data, such as for example, email addresses, phone numbers, residence addresses, usernames, user passwords, and/or credit card numbers are routinely stored on computer systems. Individuals often use personal computers to store address books containing personal data associated with different individuals. Web servers frequently store personal data associated with different groups, such as for example, clients and customers. In many cases, such computer systems are communicatively coupled to the Internet. Files including sensitive data are also routinely exchanged between different computer systems via the Internet.

Connectivity to the Internet often exposes computers systems to malicious autonomous software applications or automated agents. Automated agents are typically generated by autonomous software applications that operate as an agent for a user or a program. Real and/or virtual machines are used to generate automated agents that simulate human user activity and/or behavior to search for and gain illegal access to computer systems connected to the Internet, retrieve data from the computer systems, and generate databases of culled data for unauthorized use of the data by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents, and agents composed of sub-agents where the sub-agents themselves are individual automated agents. Examples of such automated agents include, but are not limited to, viruses, Trojans, worms, bots, spiders, and crawlers.

The increased use of computer systems that are communicatively coupled to the Internet to store and manipulate different forms of sensitive data has generated a need to format sensitive data into a form that is recognizable to a human user while posing an identification challenge to an automated agent. Storing and/or transmitting sensitive data in such a format enables human users to access the data for legitimate reasons while making it a challenge for automated agents to access the data for illegitimate reasons.

In some prior art systems, static images of sensitive data are represented in a format that includes one or more different noise components. For example, noise components in the form of various types of deformations and/or distortations are introduced into the static image representation of the sensitive data. For example, in a CAPTCHA (Completely Automated Public Turing Test To Tell Computers And Humans Apart) representation of data, noise is deliberately and/or strategically integrated into the static image representation of the sensitive data in an attempt to protect the sensitive data from automated agents that may gain unauthorized access to the data. Unfortunately, continuous advances in optical character recognition technologies have operated to defeat many of the different static image CAPTCHA representations of sensitive data.

### BRIEF DESCRIPTION OF THE DRAWINGS

FIG. 1 is a block diagram of a system that may be used to implement one embodiment of generating a representation of a symbol that presents an identification challenge for an automated agent;

FIG. 2 is a block diagram of one embodiment of a symbol identification challenge generator for generating a representation of a symbol that presents an identification challenge for an automated agent;

FIG. 3 an example of a symbol image format having a block font format defined by one embodiment of a symbol format definition module for a symbol “1”.

FIG. 4 is an example of an intermediate symbol image of the symbol “1” of FIG. 3 where each of the image blocks in the image field has been assigned an initial angle value S₀ by one embodiment of the symbol image definition module;

FIG. 5 is an example of an intermediate symbol image of the symbol “1” of FIG. 4 where a color tone percentage C % has been determined by one embodiment of the symbol image definition module for each of the image blocks in the image field;

FIG. 6 is an example of color tone symbol image of the symbol “1” of FIG. 4 where each of the image blocks in the image field has been assigned a perturbed angle value S_{P} by one embodiment of the symbol image definition module;

FIG. 7 is an example of a color tone symbol image of the symbol “1” of FIG. 4 where a color tone percentage C % has been determined by one embodiment of the symbol image definition module for each of the image blocks in the image field;

FIG. 8 is an example of a gray color tone symbol image of the color tone symbol image of the symbol “1” of FIG. 4 defined by one embodiment of a symbol image definition module;

FIG. 9 is an example of a base challenge image of the symbol “1” of FIG. 4 identifying the base challenge image angle values S_{BCI} derived by one embodiment of the challenge image generation module for each of the image blocks in the image field;

FIG. 10 is an example of a base challenge image of the symbol “1” of FIG. 4 where a color tone percentage C % has been determined by one embodiment of the challenge image generation module for each of the image blocks in the image field;

FIG. 11 is an example of a gray color tone base challenge image of the color tone symbol image of the symbol “1” of FIG. 4 generated by one embodiment of a challenge image generation module;

FIG. 12 is an example of a “negative” version of the color tone symbol image of FIG. 8 generated by one embodiment of a display mechanism;

FIG. 13 is an illustrative example of a secondary challenge image generated by one embodiment of the display mechanism via the application of a color offset o of 30;

FIG. 14 is an illustrative example of another secondary challenge image generated by one embodiment of the display mechanism via the application of a color offset o of 90;

FIG. 15 is an illustrative example of another secondary challenge image generated by one embodiment of the display mechanism via the application of a color offset o of 120;

FIG. 16 is an illustrative example of another secondary challenge image generated by one embodiment of the display mechanism via the application of a color offset o of 180;

FIG. 17 is one embodiment of a method of generating a representation of a symbol that poses an identification challenge for an automated agent;

FIG. 18 is another embodiment of a method of generating a representation of a symbol that poses an identification challenge for an automated agent;

FIG. 19 is another embodiment of a method of generating a representation of a symbol that poses an identification challenge for an automated agent; and

FIG. 20 is another embodiment of a method of generating a representation of a symbol that poses an identification challenge for an automated agent.

### DETAILED DESCRIPTION OF THE PREFERRED EMBODIMENTS

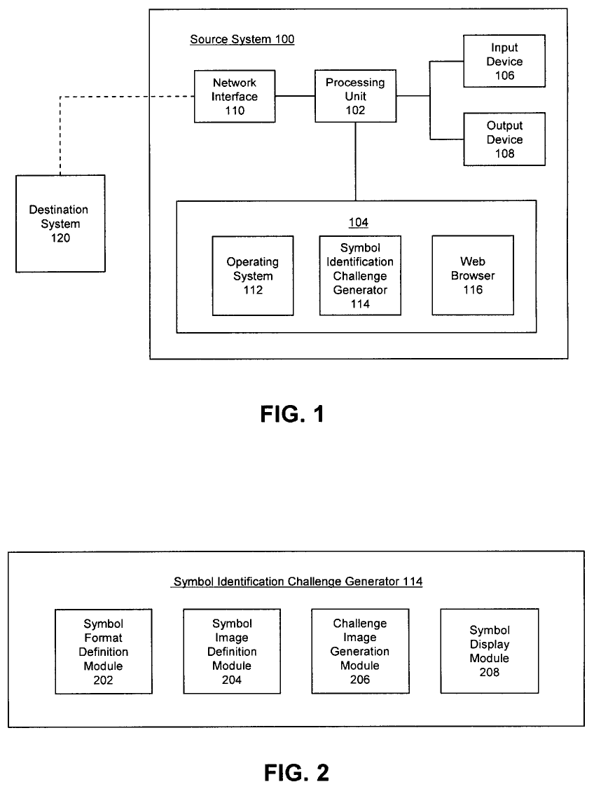

Referring to FIG. 1, a block diagram of a system 100 that may be used to implement one embodiment of generating a representation of a symbol that presents an identification challenge for an automated agent is shown. Examples of devices that may incorporate the system 100 include, but are not limited to, personal computers, personal device assistants, and cellular telephones. In one embodiment, the system 100 generally includes a processing unit 102 communicatively coupled to a memory 104, one or more input devices 106, one or more output devices 108, and a network interface 110.

The processing unit 102 generally includes a processor or controller. In one embodiment, the memory 104 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. Examples of input devices 106 include, but are not limited to, a keyboard, a scanner, and a mouse. Examples of output devices 108 include, but are not limited to, a display device and a printer. In one embodiment, the network interface 110 is an Internet interface port. In one embodiment, the system 100 can be communicatively coupled to another computing device, such as for example a destination system 120, via the network interface 110.

In one embodiment, the memory 104 generally includes an operating system 112 and a symbol identification challenge generator 114. Examples of operating systems that may be used include, but are not limited to, versions of Microsoft Windows® operating systems, versions of Java virtual machines, versions of Linux, versions of Apple Machintosh® operating systems, different types of embedded operating systems (such as for example Palm OS®), mainframe operating systems (such as for example Unix®), and proprietary operating systems (such as for example, IRIX). Additional examples of operating systems include distributed virtual operating systems that can be deployed using a wire protocol (such as for example TCP/IP), a message protocol (such as for example HTTP), any number of formatting standards (such as for example HTTP and SVG), and scripting languages (such as for example Javascript).

In one embodiment, the memory includes a web browser 116. Examples of web browsers 116 that may be used include, but are not limited to, Firefox® and Internet Explorer®. In alternative embodiments, the memory 104 may include additional application modules that facilitate the operation of the system 100. The processing unit 102 generally retrieves and executes machine readable instructions or software programs that are stored in the memory 104.

Referring to FIG. 2 a block diagram of one embodiment of a symbol identification challenge generator 114 for generating a representation of a symbol that presents an identification challenge for an automated agent is shown. The symbol identification challenge generator 114 generally includes a symbol format definition module 202, a symbol image definition module 204, a challenge image generation module 206, and a symbol display module 208. In one embodiment, the symbol format definition module 202, the symbol image definition module 204, the challenge image generation module 206, and the symbol display module 208 are all included within a single device. In another embodiment, the symbol format definition module 202, the symbol image definition module 204, the challenge image generation module 206, and the symbol display module 208 are distributed over one or more communicatively coupled devices. In another embodiment, the symbol identification challenge generator 114 includes a symbol format definition module 202, a symbol image definition module 204, a challenge image generation module 206. The symbol display module 208 is stored in the memory 104 for transmission to another system to facilitate the display of the symbol identification challenge on that system.

Symbol data representative of a symbol is received at the symbol format definition module 202. In one embodiment, the symbol data is received at the system 100 via an input device 106. In one embodiment, the symbol data is received at the system 100 via the network interface 110. In one embodiment, a symbol consists of one or more alphanumeric characters. In one embodiment, the symbol data consists of an ASCII representation of the one or more alphanumeric characters. In one embodiment, the symbol data consists of an image representation of the one or more alphanumeric characters.

In one embodiment, the symbol consists of one or more non-alphanumeric images, such as for example, icons, directional arrows, descriptive directions, descriptive problems, and/or company logos. Examples of icons include, but are not limited to, a happy face, star, stop sign, traffic light, speaker, eye, magnifying glass, lightning bolt, heart, checkmark, no (red circle with a line through it). Examples of directional arrows include, but are not limited to, sequence of left, right, up, down, circular, back and forth, button clicks, and compass point directions. An example of descriptive direction is “click on plaid square.” And example of a descriptive problem is “what is two plus two?”

The symbol is represented using symbol data representations in, such as for example, including, but not limited to, BMP (Windows Bitmap®), GIF (Compuserve Graphical Image Format), PNG (Portable Network graphics), SVG (Scalable Vector Graphics), VRML (Virtual Reality Markup Language), WMF (Windows MetaFile®), AVI (Audio Visual Interleave), MOV (Quicktime Movie), SWF (Shockwave Flash), DirectX, OpenGL, Java, Windows®, MacOS®, Linux, PDF (portable document format), JPEG (Joint Photographic Experts Group), or MPEG (Moving Picture Experts Group).

The symbol format definition module 202 defines a symbol image format for the received symbol data. In one embodiment, the symbol image format is recognizable to both a human user and an automated agent. Referring to FIG. 3, an example of a symbol image format having a block font format defined by one embodiment of a symbol format definition module 202 for a symbol “1” is shown. It should be noted that while an example of a format for a symbol image has been described, alternative formats for symbol images may be used. In one embodiment, the symbol format definition module 202 provides a user with the option of selecting one of a number of different available formats for defining a symbol image format.

Referring back to FIG. 2, the symbol image format generated by the symbol format generation module 202 is received by the symbol image definition module 204. The symbol image definition module 204 generates a color tone symbol image of the symbol associated with the received symbol data using the received symbol image format. The symbol image definition module 204 divides an image field into a plurality of image blocks. In one embodiment, the symbol image definition module 204 divides the image field into a plurality of uniform image blocks. In one embodiment, the image field is divided into a plurality of non-uniform image blocks. In one embodiment, the image blocks are generally square shaped image blocks.

The symbol image definition module 204 defines an intermediate symbol image using a first subset of the plurality of image blocks and a background of the intermediate symbol image using a second subset of the plurality of image blocks. In one embodiment, the second subset of the plurality of image blocks consist of the image blocks in the plurality of image blocks that are not used in the definition of the intermediate symbol image.

In one embodiment, a specific color is used to depict the symbol identification challenge. In one embodiment, the color is one of many selectable colors. In one embodiment, the color is a gray color. In one embodiment, a range of the color tones are used to represent the symbol identification challenge. In one embodiment, the range of color tones is a selectable range of color tones. In one embodiment, the image blocks used to define the intermediate symbol image are designated using the darkest color tone from the range of color tones and the image blocks used to define the background of the intermediate symbol image are designated using the lightest color tone from the range of color tones. In one embodiment, the image blocks used to define the intermediate symbol image are designated using the lightest color tone from the range of color tones and the image blocks used to define the background of the intermediate symbol image are designated using the darkest color tone from the range of color tones.

In one embodiment, initial angle values S₀ are assigned to each of the plurality of image blocks. In one embodiment, an initial angle value S₀ of 90° is assigned to each of the image blocks used to define the intermediate symbol image and an initial angle value S₀ of 0° is assigned to each of the image blocks used to define the background of the intermediate symbol image. In one embodiment, an initial angle value S₀ of 0° is assigned to each of the image blocks used to define the intermediate symbol image and an initial angle value S₀ of 90° is assigned to each of the image blocks used to define the background of the intermediate symbol image.

Referring to FIG. 4, an example of an intermediate symbol image of the symbol “1” of FIG. 3 where each of the image blocks in the image field has been assigned an initial angle value S₀ by one embodiment of the symbol image definition module 204 is shown. An initial angle value S₀ of 90° has been assigned to each of the image blocks used to define the intermediate symbol image and an initial angle value S₀ of 0° has been assigned to each of the image blocks used to define the background of the intermediate symbol image.

In one embodiment, each of the color tones in the range of color tones used to generate the symbol identification challenge is defined by a color tone percentage C %. In one embodiment, the lightest color tone in the range of color tones corresponds to a color tone percentage C % of 0% and the darkest color tone in the range of color tones corresponds to a color tone percentage C % of 100%. In one embodiment, the lightest color tone in the range of color tones corresponds to a color tone percentage C % of 100% and the darkest color tone in the range of color tones corresponds to a color tone percentage C % of 0%. In one embodiment, the color tone percentage C % for each individual image block in the image field is determined using Equation (1) where the ABS function is an absolute value function and the color tone percentage C % is rounded to the closest integer value.

C%=(1−(ABS(90−S₀)/90))*100 Equation (1)

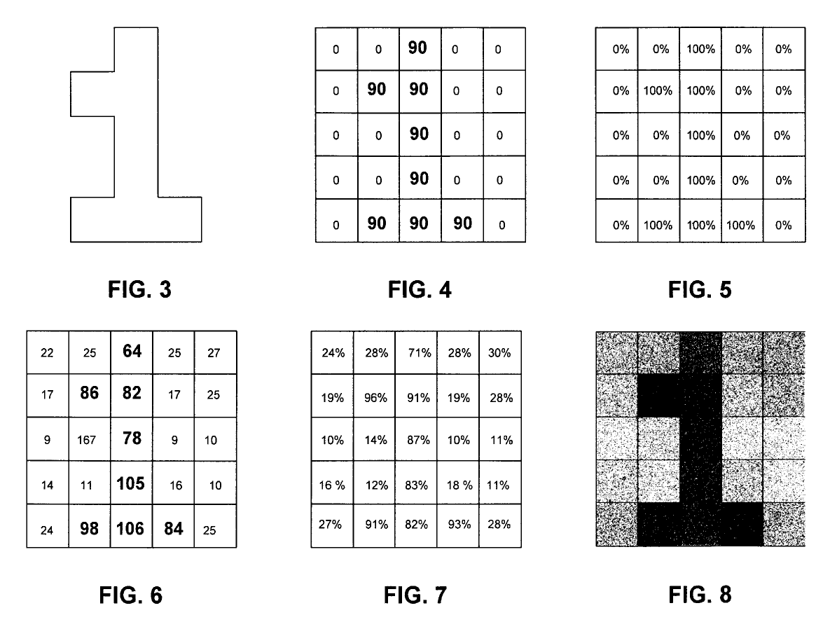

Referring to FIG. 5 an example of an intermediate symbol image of the symbol “1” of FIG. 4 where a color tone percentage C % has been determined by one embodiment of the symbol image definition module 204 for each of the image blocks in the image field using the relationship defined in Equation (1) is shown. The lightest color tone in the color tone range corresponds to a color tone percentage C % of 0% and the darkest color tone in the color tone range corresponds to a color tone percentage C % of 100%.

Referring back to FIG. 2, the symbol image definition module 204 selects a color tone from the range of color tones for each individual image block in the image field. The symbol image definition module 204 selects a first range of color tones of the color for use with the symbol image blocks and a second range of color tones of the color for use with the background image blocks thereby creating a color tone contrast between the symbol image blocks and the background image blocks in the image field. In one embodiment, the first range of color tones is relatively darker than the second range of color tones. In one embodiment, the second range of color tones is relatively lighter than the second range of color tones. In one embodiment, each individual color tone for each of the individual symbol image blocks is randomly selected from the first range of color tones and each individual color tone for each of the individual background image blocks is selected from the second range of color tones.

In one embodiment, the symbol image definition module 204 divides the entire range of available color tones into a relatively lighter range of color tones and a relatively darker range of color tones. The symbol image definition module 204 selects a range of light color tones from the available range of relatively lighter color tones and a range of dark color tones from the available range of relatively darker color tones. The light range of color tones is used as one of the first and second range of color tones and the dark range of color tones is used as the other one of the first and second range of color tones.

In one embodiment, each of the initial angle values S₀ of each of the image blocks in the image field is individually perturbed by an associated angle perturbation value r using a color tone generation function thereby generating a perturbed angle value S_{P} for each image block in the image field. In one embodiment, an angle perturbation limit r_{L} is selected from a defined range of angle perturbation limits. In one embodiment, an angle perturbation limit r_{L} is randomly selected from a pre-defined range of angle perturbation limits. In one embodiment, the pre-defined range of angle perturbation limits ranges from approximately 45° to approximately 90°. The range of available angle perturbation values r is defined by the selected angle perturbation limit r_{L}. The range of angle perturbation values r ranges from approximately −r_{L}/2 to approximately +r_{L}/2.

Angle perturbation values r selected from the range of angle perturbation values defined by the angle perturbation limit r_{L} are applied to the initial angle values S₀ of the image blocks in the image field using the color tone generation function defined in Equation (2) (see below) thereby generating the associated perturbed angle value Sₚ for each image block in the image field. In one embodiment, the angle perturbation values rare randomly generated angle perturbation values r. In other words, each of the image blocks in the image field is individually perturbed by an associated randomly generated angle perturbation value r generated from the range of angle perturbation values r defined by the angle perturbation limit r_{L} using the color tone generation function. More specifically, the perturbed angle value S_{P} for each image block in the image field is generated using the color tone generation function defined in Equation (2):

S_{P}=MOD (S₀±(RAND( )*r_{L}/2,180) Equation (2)

The color tone generation function defined by Equation (2) is applied to an image block by first randomly generating a number using a RAND function. The randomly generated number is multipled by the value of r_{L}/2 thereby generating the angle perturbation value r for that image block. The angle perturbation value r is either added or substracted from the initial angle value S₀ of the image block thereby generating the first term of the MOD function. The MOD function is implemented by dividing the first term of the MOD function by the second term, 180. The remainder of the division operation is the perturbed angle value S_{P}. of the image block.

Referring to FIG. 6, an example of color tone symbol image of the symbol “1” of FIG. 4 where each of the image blocks in the image field has been assigned a perturbed angle value S_{P} by one embodiment of the symbol image definition module 204 is shown. An angle perturbation limit r_{L} of 60° has been used and the range of randomly generated angle perturbation values r for each image block in the image field ranges from a −r_{L}/2 of −30 to a +r_{L}/2 of +30.

As mentioned previously, each of the color tones in the range of color tones used to generate the symbol identification challenge is defined by a color tone percentage C %. In one embodiment, the color tone percentage C % for each individual image block in the image field is determined using Equation (3) where the ABS function is an absolute value function and the color tone percentage C % is rounded to the closest integer value.

C%=(1−(ABS(90−S_{P})/90))*100 Equation (3)

Referring to FIG. 7 an example of a color tone symbol image of the symbol “1” of FIG. 4 where a color tone percentage C % has been determined by one embodiment of the symbol image definition module 204 for each of the image blocks in the image field using the relationship defined in Equation (3) is shown. The lightest color tone in the color tone range corresponds to a color tone percentage C % of 0% and the darkest color tone in the color tone range corresponds to a color tone percentage C % of 100%. Referring to FIG. 8, an example of a gray color tone symbol image of the color tone symbol image of the symbol “1” of FIG. 4 defined by one embodiment of a symbol image definition module 204 is shown. Each image block in the image field has been colored with a gray color tone corresponding to the color tone percentage C % associated with that image block.

Referring back to FIG. 2, the challenge image generation module 206 generally receives the color tone symbol image, selects a color tone offset o and applies the selected color tone offset o using a color tone function thereby generating a base challenge image or a base non-symbol image. In one embodiment, the challenge image generation module 206 applies the selected color tone offset o using the color tone function to a selected area of the image field thereby generating the base challenge image. In one embodiment, the selected area of the image field is the entire image field. In other words, the challenge image generation module 206 applies the selected color tone offset o using the color tone function to the entire image field thereby generating the base challenge image.

In one embodiment, the color tone offset o is selected from a range of color tone offsets o ranging from approximately 0° to approximately 180°. In one embodiment, the color tone offset o is a randomly generated value. The challenge image generation module 206 applies the selected color tone offset o using the color tone function to the perturbed angle value S_{P} of each of the image blocks in the image field and generates a base challenge image angle value S_{BCI} for each image block in the image field thereby generating the base challenge image. More specifically, the base challenge image angle value S_{BCI} for each image block in the image field is generated using the color tone function defined in Equation (4):

S_{BCI}=MOD (S_{P}+o,180) Equation (4)

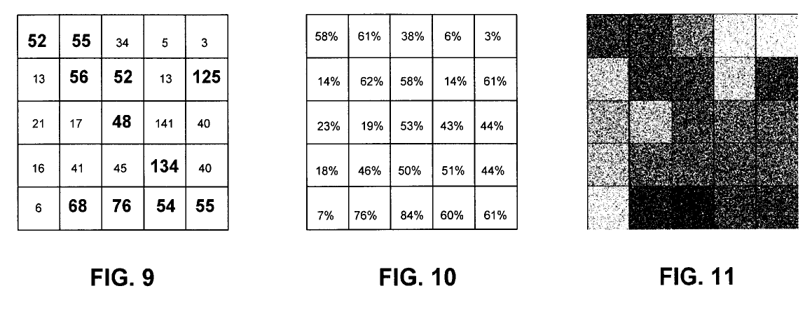

The color tone function defined by Equation (4) applies the selected color tone offset to an image block by adding the selected color offset o to the perturbed angle value S_{P} for that image block thereby generating the first term of the MOD function. The MOD function is implemented by dividing the first term of the MOD function by the second term, 180. The remainder of the division operation is the perturbed angle value S_{BCI} of the image block. This process is repeated by applying the selected color offset o using color tone function to each of the image blocks in the image field. Referring to FIG. 9, an example of a base challenge image of the symbol “1” of FIG. 4 identifying the base challenge image angle values S_{BCI} derived by one embodiment of the challenge image generation module 206 for each of the image blocks in the image field is shown. The challenge image generation module 206 generated the base challenge image angle values S_{BCI} for each of the image blocks in the image field by applying a color offset o of 30 using the color tone function.

The color tone percentage C % for each individual image block in the image field is determined using Equation (5) where the ABS function is an absolute value function and the color tone percentage C % is rounded to the closest integer value.

C%=(1−(ABS(90−S_{BCI})/90))*100 Equation (5)

Referring to FIG. 10 an example of a base challenge image of the symbol “1” of FIG. 4 where a color tone percentage C % has been determined by one embodiment of the challenge image generation module 206 for each of the image blocks in the image field using the relationship defined in Equation (5) is shown. The lightest color tone in the color tone range corresponds to a color tone percentage C % of 0% and the darkest color tone in the color tone range corresponds to a color tone percentage C % of 100%. Referring to FIG. 11, an example of a gray color tone base challenge image of the color tone symbol image of the symbol “1” of FIG. 4 generated by one embodiment of a challenge image generation module 206 is shown. Each image block in the image field has been colored with a gray color tone corresponding to the color tone percentage C % associated with that image block.

In one embodiment, the symbol display module 208 receives the base challenge image, also referred to as the base non-symbol image, and generates one or more secondary challenge images and the color tone symbol image by applying one or more color tone offsets o using the color tone function to the base challenge image. The secondary challenge images are also be referred to as secondary non-symbol images. In one embodiment, the one or more color tone offsets o are selected from a range of color tone offsets o ranging from approximately 0° to approximately 180°. In one embodiment, the one or more color tone offsets o are randomly generated values. The symbol display module 208 applies each of the selected one or more color tone offsets o the base challenge image angle values S_{BCI} of each of the image blocks in the image field and generates a secondary challenge image angle value S_{SCI} for each image block in the image field thereby generating associated secondary challenge images. More specifically, the secondary challenge image angle value S_{SCI} for each image block in the image field is generated using the color tone function defined in Equation (6):

S_{SCI}=MOD(S_{BCI}+o,180) Equation (6)

The color tone percentage C % for each individual image block in the image field is determined using Equation (7) where the ABS function is an absolute value function and the color tone percentage C % is rounded to the closest integer value.

C%=(1−(ABS(90−S_{SCI})/90))*100 Equation (7)

The symbol display module 208 organizes the base challenge image, the one or more secondary challenge images, and the color tone symbol image into a slide show format. The symbol display module 208 includes a display mechanism that is operable to sequentially display the base challenge image, the one or more secondary challenge images, and the color tone symbol image in a slide show format. The system 100 transmits the slide show format of the base challenge image, the one or more secondary challenge images, the color tone symbol image, and a copy of the display mechanism from the source system 100 to the destination system 120.

The display mechanism sequentially displays the base challenge image, the one or more secondary challenge images, and the color tone symbol image at the destination system 120. In one embodiment, the display mechanism randomly selects the order of the sequential display of the base challenge image, the one or more secondary challenge images, and the color tone symbol image. In one embodiment, the display mechanism repeats the sequential display of the base challenge image, the one or more secondary challenge images, and the color tone symbol image a pre-defined number of times. In one embodiment, the display mechanism repeats the sequential display of the base challenge image, the one or more secondary challenge images, and the color tone symbol image responsive to a repeat display command received at the destination system 120.

In one embodiment, the symbol display module 208 receives the base challenge image, also referred to as the base non-symbol image, and resets the color tone offset o associated with the base challenge image to an initial value. In one embodiment, the symbol display module 208 resets the color tone offset o associated with the base challenge image to an initial value of “0”. The symbol display module 208 includes a display mechanism. In one embodiment, the symbol display module 208 transmits the base challenge image and a copy of the display mechanism from the source system 100 to the destination system 120.

The display mechanism 208 generates one or more secondary challenge images by applying one or more color tone offsets o using the color tone function of Equation (6) to the base challenge image. The secondary challenge images are also be referred to as secondary non-symbol images. In one embodiment, the one or more color tone offsets o are selected from a range of color tone offsets o ranging from approximately 0° to approximately 180°. In one embodiment, the color tone offset o is a randomly generated value. The display mechanism applies each of the selected one or more color tone offsets o using the color tone function to the base challenge image angle values S_{BCI} of each of the image blocks in the image field and generates a secondary challenge image angle value S_{SCI} for each image block in the image field thereby generating secondary challenge images associated with each of the selected color tone offsets o.

Two types of color tone symbol images can be generated by the display mechanism, the color tone symbol image originally generated by the symbol definition module 204 and a “negative” version of the color tone symbol image. When the display mechanism selects a negative value of the color tone offset o that was originally applied to the color tone symbol image to generate the base challenge image, and applies the selected negative value of the color tone offset o using the color offset function of Equation (6) to the base challenge image angle values S_{BCI} of each of the image blocks in the image field, the display mechanism generates the perturbed angle values S_{P} for each of the image blocks in the image field thereby generating the color tone symbol image as originally generated by the symbol definition module 204 again. This relationship is summarized by Equation (8) below:

S_{P}=MOD(S_{BCI}−o,180) Equation (8)

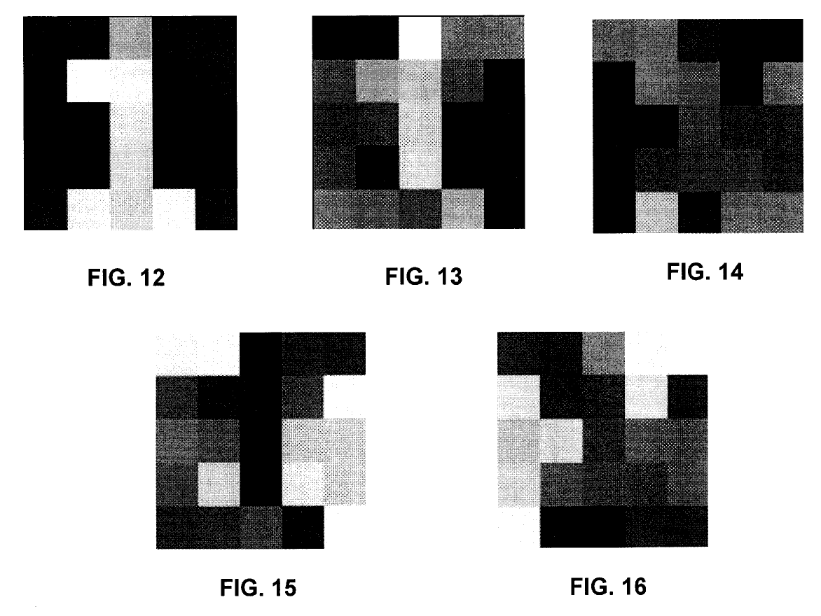

When the display mechanism selects a color tone offset that is approximately equal to the sum of the negative value of the color tone offset o that was originally applied to the color tone symbol image to generate the base challenge image application and a value of 90, and applies the selected color tone offset using the color offset function of Equation (6) to the base challenge image angle values S_{BCI} of each of the image blocks in the image field, the display mechanism generates a “negative” version of the color tone symbol image as originally generated by the symbol definition module 204 again. Referring to FIG. 12, an example of a “negative” version of the color tone symbol image of FIG. 8 generated by one embodiment of a display mechanism is shown. The color tone symbol image illustrated in FIG. 8 uses dark color tones for the symbol image blocks and light color tones for the background image blocks, the “negative” version of the color tone symbol image illustrated in FIG. 12 uses light color tones for the symbol image blocks and dark color tones for the background image blocks.

Referring to FIGS. 13, 14, 15, and 16, illustrative examples of secondary challenge images generated by one embodiment of the display mechanism via the application of color offsets o of 30, 90, 120, and 180, respectively, using the color tone function of Equation (6) to the base challenge image illustrated in FIG. 11 are shown.

The display mechanism sequentially displays each of the base challenge image, the color tone symbol image, the “negative” version of the color tone image, and/or one or more secondary challenge images at the destination system 120 in a slide show format. In one embodiment, the display mechanism randomly selects color tone offsets o and displays the associated image at the destination system 120. In one embodiment, the display mechanism incrementally increases the color tone offset o from approximately 0 to approximately 180 and applies each of the incrementally increased color tone offsets o to the base challenge image using the color offset function of Equation (6) to generate an image associated with the applied color tone offset o for display at the destination system 120.

In one embodiment, the display mechanism that is transmitted from the source system 100 to the destination system 120 includes a color tone offset graphical user interface (GUI). The color tone offset GUI is displayed at the destination system 120 and enables a user to selectively apply one or more color tone offsets o to the base challenge image. The display mechanism applies the user selected color offset o to the base challenge image and displays the image associated the selected color tone offset o at the destination system 120.

In one embodiment, the symbol display module 208 stores the base challenge image at the source system 100. When a user wishes to access the symbol, the source system 100 retrieves the base challenge image and the display mechanism generates the color tone offset GUI. The color tone offset GUI is displayed at the source system 100 and enables a user to selectively apply one or more color tone offsets o to the base challenge image. The display mechanism applies the user selected color offset o to the base challenge image and displays the image associated the selected color tone offset o at the source system 100. It should be noted that while one type of color tone function is described, the use of alternative color tone functions that enable the use of color tone offsets to generate alternative versions of secondary challenge images and the color tone symbol image may be used. Furthermore, while the application of the color tone offsets to the base challenge image using a color tone function has been described, the color tone offsets may be applied to the color tone symbol image using the color tone function to generated secondary challenge images.

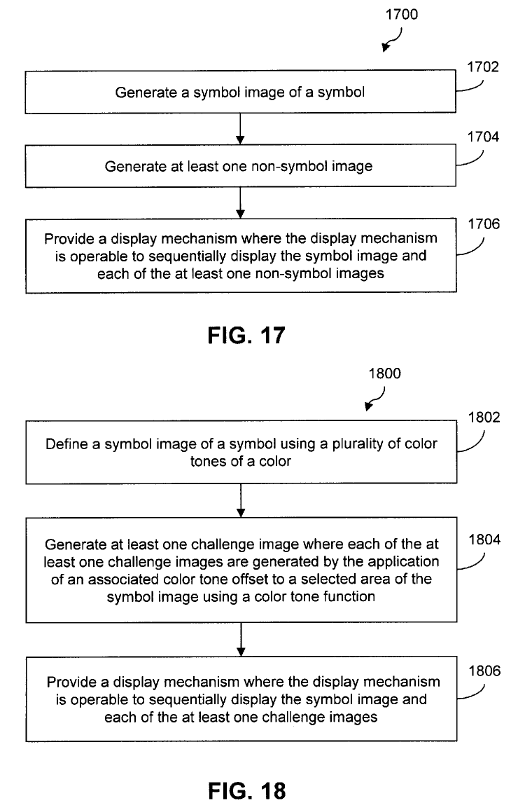

Referring to FIG. 17 one embodiment of a method 1700 of generating a representation of a symbol that poses an identification challenge for an automated agent is shown. A symbol image of a symbol is generated at step 1702 and at least one non-symbol image is generated at step 1704. A display mechanism is provided that is operable to sequentially display the symbol image and the at least one non-symbol image at step 1706. While the steps in the method 1700 have been described in a particular order, the steps may be performed in a different order or additional steps may be performed in addition to the described steps.

In one embodiment, a computer readable medium stores a computer executable program for generating a representation of a symbol that poses an identification challenge for an automated agent. The computer readable medium includes computer readable code for generating a symbol image of a symbol, computer readable code for generating at least one non-symbol image, and computer readable code for providing a display mechanism. The display mechanism is operable to sequentially display the symbol image and each of the at least one non-symbol images.

Referring to FIG. 18 another embodiment of a method 1800 of generating a representation of a symbol that poses an identification challenge for an automated agent is shown. A symbol image of a symbol is defined using a plurality of color tones of a color at step 1802. At least one challenge image is generated, where each of the at least one challenge images is generated by the application of an associated color tone offset to a selected area of the symbol image using a color tone function at step 1804. A display mechanism is provided at step 1806. The display mechanism is operable to sequentially display the symbol image and each of the at least one challenge images. While the steps in the method 1800 have been described in a particular order, the steps may be performed in a different order or additional steps may be performed in addition to the described steps.

In one embodiment, a computer readable medium stores a computer executable program for generating a representation of a symbol that poses an identification challenge for an automated agent. The computer readable medium includes computer readable code for defining a symbol image of a symbol using a plurality of color tones of a color, computer readable code for generating at least one challenge image, where each of the at least one challenge images is generated by the application of an associated color tone offset to a selected area of the symbol image using a color tone function, and computer readable code for providing a display mechanism. The display mechanism is operable to sequentially display the symbol image and each of the at least one challenge images.

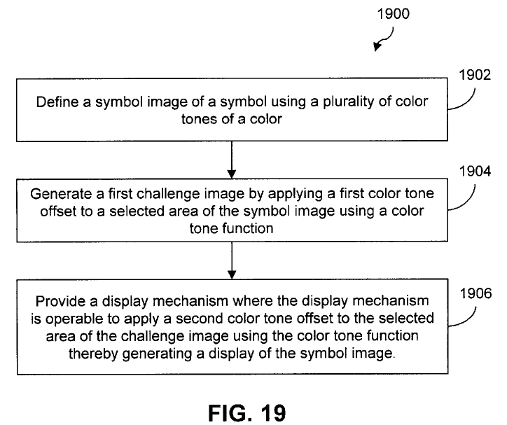

Referring to FIG. 19, another embodiment of a method 1900 of generating a representation of a symbol that poses an identification challenge for an automated agent is shown. A symbol image of a symbol is defined using a plurality of color tones of a color at step 1902. A first challenge image is generated by applying a first color tone offset to a selected area of the symbol image using a color tone function at step 1904. A display mechanism is provided at step 1906. The display mechanism is operable to apply a second color tone offset to the selected area of the challenge image using the color tone function thereby generating a display of the symbol image. While the steps in the method 1900 have been described in a particular order, the steps may be performed in a different order or additional steps may be performed in addition to the described steps.

In one embodiment, a computer readable medium stores a computer executable program for generating a representation of a symbol that poses an identification challenge for an automated agent. The computer readable medium includes computer readable code for defining a symbol image of a symbol using a plurality of color tones of a color, computer readable code for generating a first challenge image by applying a first color tone offset to a selected area of the symbol image using a color tone function, and computer readable code for providing a display mechanism. The display mechanism is operable to apply a second color tone offset to the selected area of the challenge image using the color tone function thereby generating a display of the symbol image.

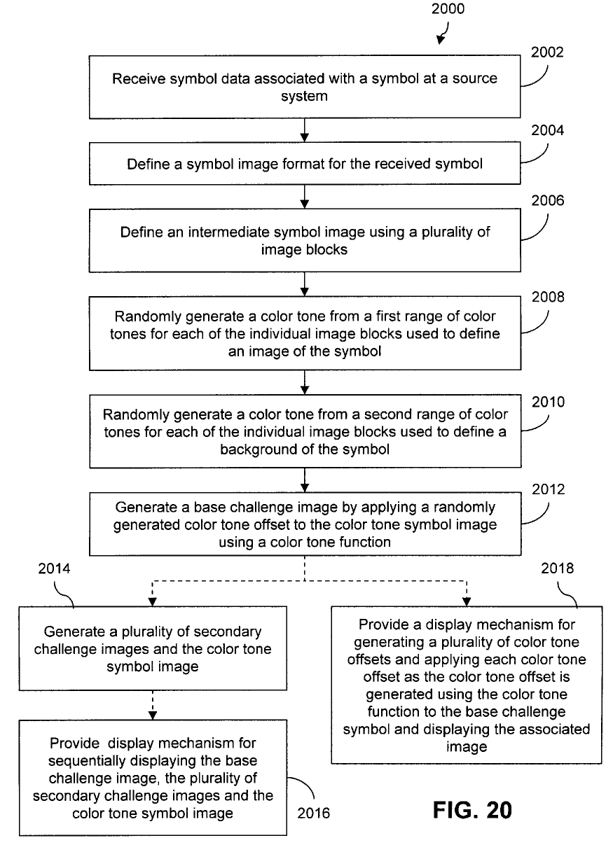

Referring to FIG. 20 another embodiment of a method 2000 of generating a representation of a symbol that poses an identification challenge for an automated agent is shown. Symbol data associated with a symbol is received at a source system 100 at step 2002. The symbol format definition module 202 defines a symbol image format for the received symbol at step 2004. The symbol image definition module 204 defines an intermediate symbol image at step 2006. More specifically, the symbol image definition module 204 divides an image field into a plurality of image blocks and defines an image of the symbol using a first subset of the plurality of image blocks and a background using a second subset of image blocks. The symbol image definition module 204 randomly generates a color tone for each of the individual image blocks that have been used to define the image of the symbol at step 2008. Each color tone is randomly generated from a first range of color tones. The symbol image definition module 204 randomly generates a color tone for each of the individual image blocks that have been used to define the background thereby generating a color tone symbol image at step 2010. Each color tone is randomly generated from a second range of color tones. The second range of color tones is either relatively lighter or relatively darker than the first range of color tones. The challenge image generation module 206 generates a base challenge image by applying a randomly generated color tone offset to the color tone symbol image using a color tone function at step 2012.

In one embodiment, the display symbol module 208 generates a plurality of secondary challenge images and the color tone symbol image by applying a number of different color tone offsets to the base challenge symbol image using a color tone function at step 2014. The base challenge image, the plurality of secondary challenge images and the color tone symbol image are organized in a slide show format. The display symbol module 208 provides one embodiment of a display mechanism for displaying a symbol identification challenge for the symbol. In other words, the display symbol module 208 provides a display mechanism for sequentially displaying the base challenge image, the plurality of secondary challenge images and the color tone symbol images. In one embodiment, the symbol identification challenge generator 114 transmits the base challenge symbol image, the plurality of secondary challenge symbols and the color tone symbol from the source system 100 to a destination system 120. The display mechanism sequentially displays the base challenge symbol image, the plurality of secondary challenge symbols and the color tone symbol at the destination system 120 in a slide show format.

In one embodiment, symbol display module 208 provides another embodiment of a display mechanism for displaying a symbol identification challenge for the symbol. The symbol display module 208 provides a display mechanism for generating a plurality of color tone offsets, applying each color tone offset as the color tone offset is generated to the challenge image using the color tone function and displaying the associated image. Depending on the color tone offset used, the associated image is a secondary challenge symbol, the color tone symbol image or a “negative” version of the color tone symbol image. In one embodiment, the base challenge image is stored at the source system 100 and retrieved by the display mechanism upon receiving request to display the symbol identification challenge at the source system 100. In one embodiment, the base challenge image and a copy of the display mechanism is transmitted from the source system 100 to the destination system 120 and the display mechanism displays the symbol identification challenge at the source system 110. While the steps in the method 2000 have been described in a particular order, the steps may be performed in a different order. Furthermore, a subset of the described steps may be performed or additional steps may be performed in addition to the described steps.

It should be noted that while systems implemented using software or firmware executed by hardware have been described above, those having ordinary skill in the art will readily recognize that the disclosed systems could be implemented exclusively in hardware through the use of one or more custom circuits, such as for example, application-specific integrated circuits (ASICs) or any other suitable combination of hardware and/or software.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of generating a representation of a symbol that poses an identification challenge for an automated agent, the method comprising:
generating a symbol image of a symbol;
generating at least one non-symbol image; and
providing a display mechanism, the display mechanism being operable to sequentially display the symbol image and each of the at least one non-symbol images.

2. The method of claim 1, wherein generating at least one non-symbol image comprises generating at least one challenge symbol image.

3. The method of claim 1, wherein providing a display mechanism comprises providing a display mechanism that is operable to repeat the sequential display of the symbol image and each of the at least one non-symbol images.

4. The method of claim 1, wherein providing a display mechanism comprises providing a display mechanism that is operable to repeat the sequential display of the symbol image and each of the at least one non-symbol images responsive to a received input command.

5. The method of claim 1, further comprising transmitting the display mechanism, the symbol image, and the at least one non-symbol image to a destination system.

6. A computer readable medium for storing a computer executable program for generating a representation of a symbol that poses an identification challenge for an automated agent comprising:
computer readable code for generating a symbol image of a symbol;
computer readable code for generating at least one non-symbol image; and
computer readable code for providing a display mechanism, the display mechanism being operable to sequentially display the symbol image and each of the at least one non-symbol images.

7. The computer readable medium of claim 6, wherein the computer readable code for generating at least one non-symbol image comprises computer readable code for generating at least one challenge symbol image.

8. The computer readable medium of claim 6, wherein the computer readable code for providing a display mechanism comprises computer readable code for providing a display mechanism that is operable to repeat the sequential display of the symbol image and each of the at least one non-symbol images.

9. The computer readable medium of claim 6, wherein the computer readable code for providing a display mechanism comprises computer readable code for providing a display mechanism that is operable to repeat the sequential display of the symbol image and each of the at least one non-symbol images responsive to a received input command.

10. The computer readable medium of claim 6, further comprising computer readable code for transmitting the display mechanism, the symbol image, and the at least one non-symbol image to a destination system.

11. A method of generating a representation of a symbol that poses an identification challenge for an automated agent, the method comprising:
defining a symbol image of a symbol using a plurality of color tones of a color;
generating at least one challenge image, each of the at least one challenge images being generated by the application of an associated color tone offset to a selected area of the symbol image using a color tone function; and
providing a display mechanism, the display mechanism being operable to sequentially display the symbol image and each of the at least one challenge images.

12. The method of claim 11, wherein defining a symbol image of a symbol using a plurality of color tones of a color comprises:
defining an image of the symbol in an image field using a first plurality of color tones selected from a first range of color tones of the color; and
defining a background in the image field using a second plurality of color tones selected from a second range of color tones of the color, wherein the first range of color tones is relatively darker than the second range of color tones.

13. The method of claim 11, wherein defining a symbol image of a symbol using a plurality of color tones of a color comprises:
defining an image of the symbol in an image field using a first plurality of color tones selected from a first range of color tones of the color; and
defining a background in the image field using a second plurality of color tones selected from a second range of color tones of the color, wherein the first range of color tones is relatively lighter than the second range of color tones.

14. The method of claim 11, wherein defining a symbol image of a symbol using a plurality of color tones of a color comprises:
dividing an image field into a plurality of image blocks; and
selectively applying one of the plurality of color tones to each of the plurality of image blocks to define the symbol image.

15. The method of claim 14, wherein defining a symbol image of a symbol using a plurality of color tones of a color comprises:
defining an image of the symbol and a background using first and second subsets of the plurality of image blocks, respectively;
randomly generating a first plurality of color tones from a first range of color tones of the color, each of the first plurality of color tones being generated for application to one of the first subset of image blocks; and
randomly generating a second plurality of color tones from a second range of color tones of the color, each of the second plurality of color tones being generated for application to one of the second subset of image blocks.

16. The method of claim 11, wherein generating at least one challenge image comprises generating each of the at least one challenge images by applying the associated color tone offset to an entire area of the symbol image using the color tone function.

17. The method of claim 11, wherein generating at least one challenge image comprises generating each of the at least one challenge images by applying a randomly generated color tone offset to the selected area of the symbol image using the color tone function.

18. The method of claim 11, further comprising transmitting the display mechanism, the symbol image, and the at least one challenge image to a destination system.

19. A computer readable medium for storing a computer executable program for generating a representation of a symbol that poses an identification challenge for an automated agent comprising:
computer readable code for defining a symbol image of a symbol using a plurality of color tones of a color;
computer readable code for generating at least one challenge image, each of the at least one challenge images being generated by the application of an associated color tone offset to a selected area of the symbol image using a color tone function; and
computer readable code for providing a display mechanism, the display mechanism being operable to sequentially display the symbol image and each of the at least one challenge images.

20. The computer readable medium of claim 19, wherein the computer readable code for defining a symbol image of a symbol using a plurality of color tones of a color comprises:
computer readable code for defining an image of the symbol in an image field using a first plurality of color tones selected from a first range of color tones of the color; and
computer readable code for defining a background in the image field using a second plurality of color tones selected from a second range of color tones of the color, wherein the first range of color tones is relatively darker than the second range of color tones.

21. The computer readable medium of claim 19, wherein the computer readable code for defining a symbol image of a symbol using a plurality of color tones of a color comprises:
computer readable code for defining an image of the symbol in an image field using a first plurality of color tones selected from a first range of color tones of the color; and
computer readable code for defining a background in the image field using a second plurality of color tones selected from a second range of color tones of the color, wherein the first range of color tones is relatively lighter than the second range of color tones.

22. The computer readable medium of claim 19, wherein the computer readable code for defining a symbol image of a symbol using a plurality of color tones of a color comprises:
computer readable code for dividing an image field into a plurality of image blocks; and
computer readable code for selectively applying one of the plurality of color tones to each of the plurality of image blocks to define the symbol image.

23. The computer readable medium of claim 22, wherein the computer readable code for defining a symbol image of a symbol using a plurality of color tones of a color comprises:
computer readable code for defining an image of the symbol and a background using first and second subsets of the plurality of image blocks, respectively;
computer readable code for randomly generating a first plurality of color tones from a first range of color tones of the color, each of the first plurality of color tones being generated for application to one of the first subset of image blocks; and
computer readable code for randomly generating a second plurality of color tones from a second range of color tones of the color, each of the second plurality of color tones being generated for application to one of the second subset of image blocks.

24. The computer readable medium of claim 19, wherein the computer readable code for generating at least one challenge image comprises computer readable code for generating each of the at least one challenge images by applying the associated color tone offset to an entire area of the symbol image using the color tone function.

25. The computer readable medium of claim 19, wherein the computer readable code for generating at least one challenge image comprises computer readable code for generating each of the at least one challenge images by applying a randomly generated color tone offset to the selected area of the symbol image using the color tone function.

26. The computer readable medium of claim 19, further comprising computer readable code for transmitting the display mechanism, the symbol image, and the at least one challenge image to a destination system.

27. A method of generating a representation of a symbol that poses an identification challenge for an automated agent, the method comprising:
defining a symbol image of a symbol using a plurality of color tones of a color;
generating a first challenge image by applying a first color tone offset to a selected area of the symbol image using a color tone function; and
providing a display mechanism, the display mechanism being operable to apply a second color tone offset to the selected area of the challenge image using the color tone function thereby generating a display of the symbol image.

28. The method of claim 27, wherein defining a symbol image of a symbol using a plurality of color tones of a color comprises:
defining an image of the symbol in an image field using a first plurality of color tones selected from a first range of color tones of the color; and
defining a background in the image field using a second plurality of color tones selected from a second range of color tones of the color, wherein the first range of color tones is relatively darker than the second range of color tones.

29. The method of claim 27, wherein defining a symbol image of a symbol using a plurality of color tones of a color comprises:
defining an image of the symbol in an image field using a first plurality of color tones selected from a first range of color tones of the color; and
defining a background in the image field using a second plurality of color tones selected from a second range of color tones of the color, wherein the first range of color tones is relatively lighter than the second range of color tones.

30. The method of claim 27, wherein defining a symbol image of a symbol using a plurality of color tones of a color comprises:
dividing an image field into a plurality of image blocks; and
selectively applying one of the plurality of color tones to each of the plurality of image blocks to define an image of the symbol image.

31. The method of claim 30, wherein defining a symbol image of a symbol using a plurality of color tones of a color comprises:
defining an image of the symbol and a background using first and second subsets of the plurality of image blocks, respectively;
randomly generating a first plurality of color tones from a first range of color tones of the color, each of the first plurality of color tones being generated for application to one of the first subset of image blocks; and
randomly generating a second plurality of color tones from a second range of color tones of the color, each of the second plurality of color tones being generated for application to one of the second subset of image blocks.

32. The method of claim 27, wherein generating a first challenge image by applying a first color tone offset to a selected area of the symbol image using a color tone function comprises applying the first color tone offset to an entire area of the symbol image using the color tone function.

33. The method of claim 27, wherein generating a first challenge image by applying a first color tone offset to a selected area of the symbol image using a color tone function comprises generating a first challenge image by applying a randomly generated first color tone offset to the selected area of the symbol image using the color tone function.

34. The method of claim 27, wherein providing a display mechanism comprises providing a display mechanism that is operable to sequentially display the first challenge image and the symbol image.

35. The method of claim 27, wherein providing a display mechanism comprises providing a display mechanism that is operable to generate a second challenge image by applying a third color tone offset to the selected area of the first challenge image using the color tone function, and wherein the display mechanism is operable to sequentially display the symbol image, and the first and second challenge symbols.

36. The method of claim 27, wherein providing a display mechanism comprises providing a display mechanism that is operable to display a second challenge image responsive to a received input color tone offset, the display mechanism being operable to apply the received input color tone offset to the selected area of the first challenge image using the color tone function to generate the display of the second challenge image.

37. The method of claim 27, further comprising transmitting the display mechanism, the symbol image, and the first challenge image to a destination system.

38. A computer readable medium for storing a computer executable program for generating a representation of a symbol that poses an identification challenge for an automated agent comprising:
computer readable code for defining a symbol image of a symbol using a plurality of color tones of a color;
computer readable code for generating a first challenge image by applying a first color tone offset to a selected area of the symbol image using a color tone function; and
computer readable code for providing a display mechanism, the display mechanism being operable to apply a second color tone offset to the selected area of the challenge image using the color tone function thereby generating a display of the symbol image.

39. The computer readable medium of claim 38, wherein the computer readable code for defining a symbol image of a symbol using a plurality of color tones of a color comprises:
computer readable code for defining an image of the symbol in an image field using a first plurality of color tones selected from a first range of color tones of the color; and
computer readable code for defining a background in the image field using a second plurality of color tones selected from a second range of color tones of the color, wherein the first range of color tones is relatively darker than the second range of color tones.

40. The computer readable medium of claim 38, wherein the computer readable code for defining a symbol image of a symbol using a plurality of color tones of a color comprises:
computer readable code for defining an image of the symbol in an image field using a first plurality of color tones selected from a first range of color tones of the color; and
computer readable code for defining a background in the image field using a second plurality of color tones selected from a second range of color tones of the color, wherein the first range of color tones is relatively lighter than the second range of color tones.

41. The computer readable medium of claim 38, wherein the computer readable code for defining a symbol image of a symbol using a plurality of color tones of a color comprises:
computer readable code for dividing an image field into a plurality of image blocks; and
computer readable code for selectively applying one of the plurality of color tones to each of the plurality of image blocks to define an image of the symbol image.

42. The computer readable medium of claim 41, wherein the computer readable code for defining a symbol image of a symbol using a plurality of color tones of a color comprises:
computer readable code for defining an image of the symbol and a background using first and second subsets of the plurality of image blocks, respectively;
computer readable code for randomly generating a first plurality of color tones from a first range of color tones of the color, each of the first plurality of color tones being generated for application to one of the first subset of image blocks; and
computer readable code for randomly generating a second plurality of color tones from a second range of color tones of the color, each of the second plurality of color tones being generated for application to one of the second subset of image blocks.

43. The computer readable medium of claim 38, wherein the computer readable code for generating a first challenge image by applying a first color tone offset to a selected area of the symbol image using a color tone function comprises computer readable code for applying the first color tone offset to an entire area of the symbol image using the color tone function.

44. The computer readable medium of claim 38, wherein the computer readable code for generating a first challenge image by applying a first color tone offset to a selected area of the symbol image using a color tone function comprises computer readable code for generating a first challenge image by applying a randomly generated first color tone offset to the selected area of the symbol image using the color tone function.

45. The computer readable medium of claim 38, wherein the computer readable code for providing a display mechanism comprises computer readable code for providing a display mechanism that is operable to sequentially display the first challenge image and the symbol image.

46. The computer readable medium of claim 38, wherein the computer readable code for providing a display mechanism comprises computer readable code for providing a display mechanism that is operable to generate a second challenge image by applying a third color tone offset to the selected area of the first challenge image using the color tone function, and wherein the display mechanism is operable to sequentially display the symbol image, and the first and second challenge symbols.

47. The computer readable medium of claim 38, wherein the computer readable code for providing a display mechanism comprises computer readable code for providing a display mechanism that is operable to generate a display of a second challenge image responsive to a received input color tone offset, the display mechanism being operable to apply the received input color tone offset to the selected area of the first challenge image using the color tone function to generate the display of the second challenge image.

48. The computer readable medium of claim 38, further comprising transmitting the display mechanism, the symbol image, and the first challenge image to a destination system.
